(19) United States
(12) Patent Application Publication
(10) Pub. No.: US 2005/0027966 A1
(43) Pub. Date: Feb. 3, 2005

(54) Device and method for digital signal processor code downloading

(76) Inventors: Pei-Jei Hu, Taipei (TW); Kun-Long Lin, Taipei (TW); Wei-Ming Su, Taipei (TW)

Correspondence Address: Steven M. Rabin;RABIN & BERDO, P.C., Suite 500, 1101 14th Street, N.W., Washington, DC, 20005, US

(21) Appl. No.: 10/876,344

(22) Filed: Jun. 25, 2004

Related U.S. Application Data
(63) Continuation-in-part of application No. 09/697,295, filed on Oct. 27, 2000, now abandoned.

(30) Foreign Application Priority Data
Dec. 9, 1999 (TW) 88121611

(51) Int. Cl. G06F 9/40

(52) U.S. Cl. 712/36

(57) ABSTRACT

A digital signal processor (DSP) code download device is disclosed. The device is used for downloading a DSP code comprising a Servo system control code from a re-programmable memory and then storing the DSP code in a memory. The DSP code download device includes a re-programmable memory reader for downloading the DSP code from the re-programmable memory, a download procedure controller coupled to the re-programmable memory reader and a memory accessor coupled to the download procedure controller for accessing the memory. Accordingly, when the DSP code needs to be updated or corrected, it is only necessary to program the re-programmable memory with the required version of DSP code rather than to manufacture a new control chip.

### CROSS-REFERENCE TO RELATED APPLICATION

This application is a continuation-in-part (CIP) application of the application “DEVICE AND METHOD FOR DIGITAL SIGNAL PROCESSOR CODE DOWNLOADING” with the application Ser. No. 09/697,295, and this application incorporates by reference Taiwanese application serial No. 88121611, filed Dec. 9^{th}, 1999.

### BACKGROUND OF THE INVENTION

1. Field of Invention

The present invention relates to a device and method for digital signal processor (DSP) code downloading, and more particularly the present invention relates to a DSP code download device for downloading DSP code from a re-programmable memory to a memory.

2. Description of Related Art

FIG. 1 shows a block diagram of a DSP unit within a conventional control chip. In general, the DSP unit within the control chip is used for processing digital signals that require fast processing, such as floating operation, mathematical operations for matrix or graphics etc. The DSP unit can be applied to peripheral devices, such as a compact disc-read only memory (CD-ROM) drive or a digital versatile disc (DVD) drive, which needs a high speed of signal processing. Referring to FIG. 1, the DSP code, the program code for the DSP core 14 to operate with, is conventionally built into a read only memory (ROM) 12 of the control chip 10. The DSP core 14 can use the DSP code stored in the ROM 12 to process digital data of peripheral devices controlled by the control chip 14. Accordingly, the conventional method can reduce the manufacturing cost. However, once the DSP code has bugs therein or a newer version is released, a new control chip must be manufactured because the ROM cannot be rewritten. Moreover, defected control chips cannot be sold thereby incurring cost increases.

### SUMMARY OF THE INVENTION

The present invention providing a device and method for updating DSP code comprises a Servo system control code. A DSP code download device is used to download a DSP code stored in a re-programmable memory, such as a flash memory, and then store the DSP code in a random access memory (RAM) coupled to the DSP. Accordingly, when the DSP code needs to be updated or corrected, it is only necessary to program the re-programmable memory with the required version of DSP code rather than to manufacture a new control chip.

In addition, the present invention utilizing a circuitry for downloading the DSP code. Therefore, the DSP code is efficiently downloaded and stored in the RAM when the power of a peripheral device is turned on.

Moreover, the present invention providing a peripheral device of an optoelectronic system capable of reprogramming a digital signal processor (DSP) in the optoelectronic system. The peripheral device downloads a program code from a re-programmable memory to a memory device built into the peripheral device. In this way, the peripheral device is programmed and initiated efficiently.

According to the present invention, a DSP code download device within a control chip for downloading a DSP code comprises a Servo system control code from a re-programmable memory to a memory is provided. The DSP code download device includes a re-programmable memory reader for downloading the DSP code, a download procedure controller coupled to the re-programmable memory reader, and a memory accessor coupled to the download procedure controller for accessing the memory.

According to the present invention, a control chip is provided. The control chip is coupled to a re-programmable memory in which a DSP code comprises a Servo system control code is stored. The control chip includes a DSP, a memory device coupled to the DSP, and a DSP code download device for downloading the DSP code to the memory.

According to the present invention, a method for updating a digital signal processor (DSP) code comprises a Servo system control code for controlling a Servo system of a optoelectronic system comprising of downloading the DSP code stored in the first memory to a second memory according to a pointer stored in the first memory for indicating an initial address and a code size of the DSP code. The downloaded DSP code is further decrypted and a read checksum value is calculated. Then, the decrypted DSP code is read and a write checksum value is calculated. The read and write checksum values are then compared with a predetermined checksum value for checking errors.

According to the present invention, a peripheral device of a optoelectronic system capable of reprogramming a digital signal processor (DSP) in the optoelectronic system is provided The peripheral device includes a first memory, a code downloading device, and a second memory. The first memory is for storing a first program code comprises a Servo system control code; the code downloading device coupled to the first memory is for downloading the first program code and outputting a second program code; and the second memory coupled to the code downloading device is for receiving the second program code from the code downloading device. The DSP is operative with the second program code when the program code in the second memory passes a verification test performed by the code downloading device.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. The description is made with reference to the accompanying drawings in which:

FIG. 1 (Prior Art) shows a block diagram of a conventional DSP control chip;

FIG. 2 is a block diagram of the main parts of a peripheral device according to a preferred embodiment of the present invention;

FIG. 3 is a block diagram of the main parts of a peripheral device, where a structure of the DSP download device shown in FIG. 2 is illustrated;

FIG. 4 is a flowchart of the DSP code download method according to the preferred embodiment of the present invention; and

FIG. 5 illustrates the main parts of a peripheral device of an example according to the preferred embodiment of the present invention.

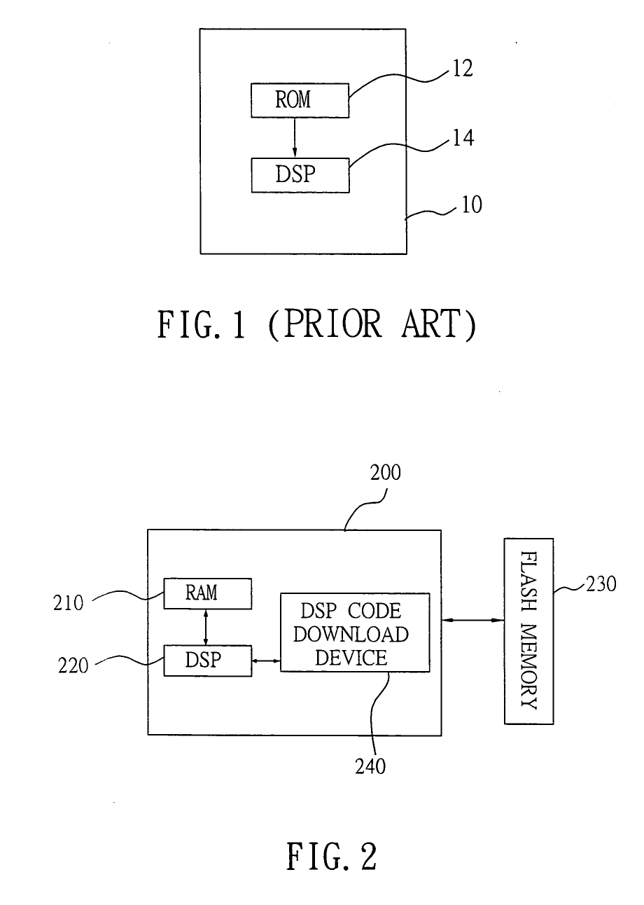

### DESCRIPTION OF THE PREFERRED EMBODIMENTS

### EXAMPLE 1

FIG. 2 illustrates a block diagram of the main components of a peripheral device according to a preferred embodiment of the present invention. The peripheral device can be, for example, a CD-ROM drive or DVD-ROM drive. As shown in FIG. 2, the peripheral device mainly includes a control chip 200 and a flash memory 230 coupled to the control chip 200. The control chip 200 includes a DSP 220, a random access memory (RAM) 210 coupled to the DSP 220, a DSP code download device 240 coupled between the RAM 210 and a flash memory 230. The flash memory 230 is used for storing data required by the control chip 200, for example, the Servo system control code required by the DSP 220 for controlling the Servo system of an optoelectronic sytem. The DSP code is encrypted for safety and security and then stored in the flash memory 230. In addition, the flash memory 230 stores a pointer and a predetermined checksum value at specific locations. The pointer is used for indicating an initial address and code size of the DSP code. The checksum value is used for checking whether errors occur during the download process. In addition, the checksum value is obtained by using a predetermined algorithm performed on the DSP code, i.e. the checksum value depends on the DSP code. The RAM 210 is used for storing the DSP code downloaded from the flash memory 230 when a peripheral device, such as a CD-ROM drive or DVD drive, is activated, whereby the DSP 220 can use the DSP code stored in the RAM 210 to process digital data from the peripheral device.

Another feature of the present invention is the utilization of a circuit, the DSP code download device 240, to download the DSP code required by the DSP from the flash memory 230 to the RAM 210. After the DSP code comprises the Servo system control code is downloaded and stored in the RAM 210, the DSP is operative with the DSP code when the DSP code in the RAM 210 passes a verification test performed by the DSP code downloading device 240.

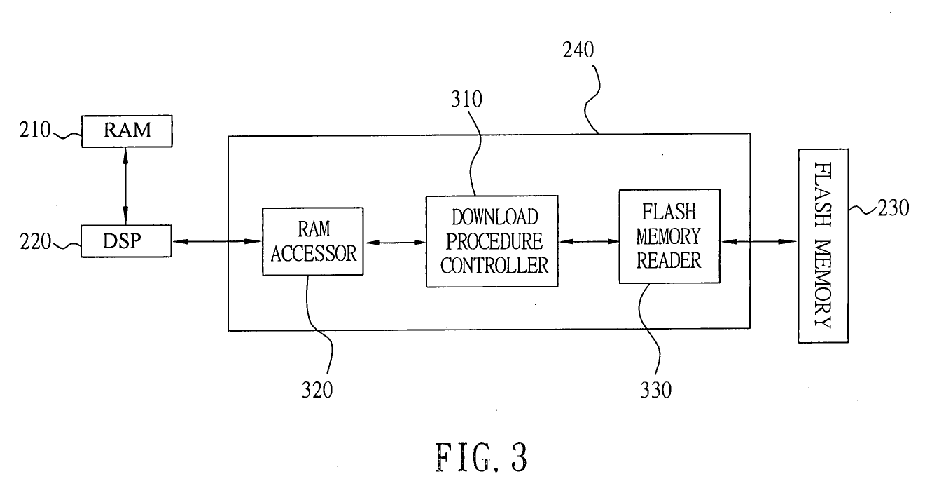

FIG. 3 is a block diagram of the main parts of a peripheral device of an optoelectronic system, where a structure of the DSP download device 240 shown in FIG. 2 is illustrated. The same numerals are used for presenting the same functional blocks. It's noted that the optoelectronic system comprises a VCD player, DVD player, and so on. As shown in FIG. 3, the DSP code download device 240 includes a download procedure controller 310, a RAM accessor 320, and a flash memory reader 330. The DSP code download device 240 is activated when a peripheral device, such as a CD-ROM or a DVD, is activated. First, the download procedure controller 310 of the DSP code download device 240 reads the pointer stored in the flash memory 230 through the flash memory reader 330. Accordingly, the download procedure controller 310 obtains the initial address and code size of the DSP code comprises the Servo system control code stored in the flash memory 230. Then, according to the information obtained from the pointer, the download procedure controller 310 controls the whole download process. The flash memory reader 330 is used to read and decrypt the DSP code contained in the flash memory 230. At the same time, a read checksum value is calculated during the DSP code download process for checking whether errors occurred. The RAM accessor 320 is used for writing the decrypted DSP code downloaded from the flash memory 230 into the RAM 210 shown in FIG. 2 through the DSP 220. In addition, the RAM accessor 320 can also read the DSP code already written into the RAM 210 through the DSP 220 to calculate a write checksum value. The write checksum value is used for checking whether errors occurred during the writing process.

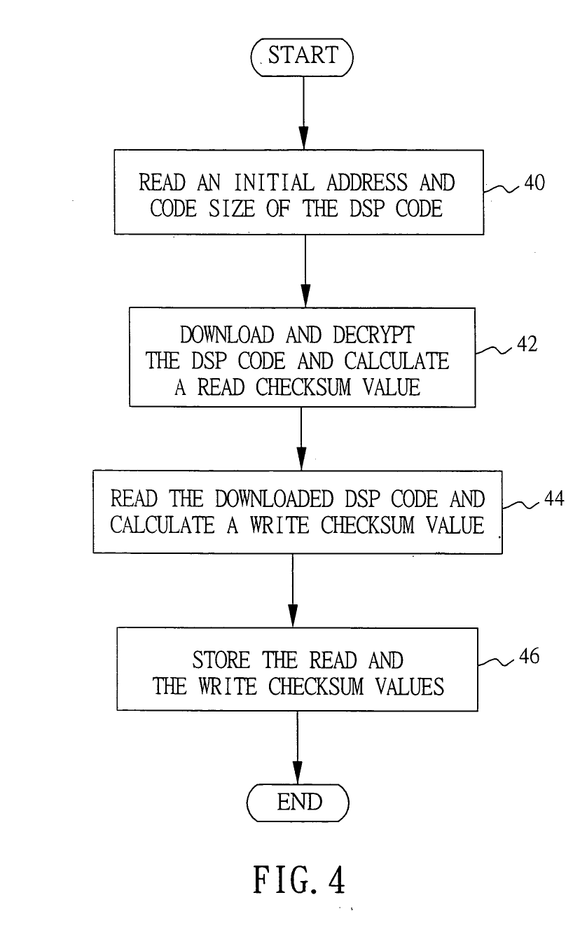

FIG. 4 shows a flowchart of the DSP code download method according to the preferred embodiment of the present invention. The method begins and proceeds to step 40. In step 40, an initial address and code size of the DSP code are read. Namely, the download procedure controller 310 shown in FIG. 3 controls the flash memory reader 330 to download the DSP code stored in the flash memory 230 according to the initial address and the code size of the DSP code.

Next, in step 42, the DSP code is downloaded and decrypted, and then a read checksum value is calculated. The download procedure controller 310 shown in FIG. 3 controls the download procedure according to the initial address and the code size of the required DSP code in step 40. During the DSP code download process, the flash memory reader 330 reads and decrypts the DSP code stored in the flash memory 230. The RAM accessor 320 then writes the decrypted DSP code into the RAM 210 through the DSP 220. In addition, a read checksum value is calculated for checking whether errors occurred during reading the DSP code download process from the flash memory 230.

In step 44, a write checksum value is calculated. The RAM accessor 320 reads the decrypted DSP code already stored in the RAM 210 through the DSP 220 and calculates a write checksum value for checking whether the RAM 210 receives a correct DSP code. In step 46, the read and write checksum values are stored for an initial check and the DSP code download process is completed. By comparing the predetermined checksum value with the read checksum value, it can be determined whether the DSP code contains errors as a result of download and decryption processes. In addition, by comparing the predetermined checksum value with the write checksum value, it can be ascertained whether the DSP code is erroneous in the writing process. Moreover, the comparisons can be performed by firmware, resulting in a faster determination as compared with other implementations. If errors are found, it means that the initiation process fails. If no errors are found, the DSP 220 is initiated successfully and the DSP 220 begins to operate according to the DSP code stored in the RAM 210.

### EXAMPLE 2

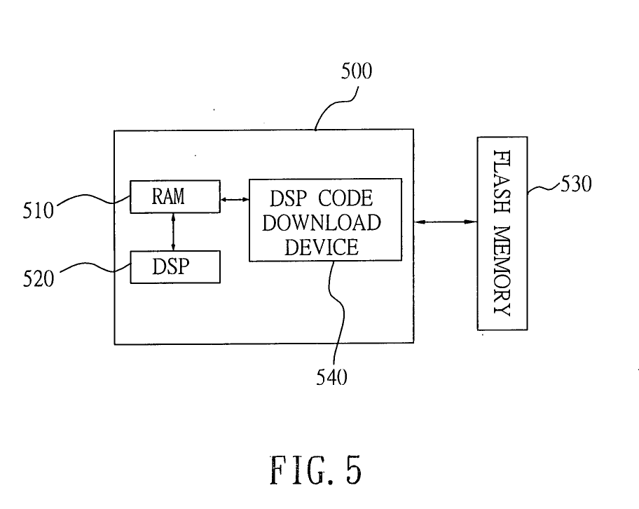

FIG. 5 shows a block diagram of another example of the main parts of a peripheral device according to the preferred embodiment of the present invention. As shown in FIG. 5, the peripheral device includes a control chip 500 and a flash memory 530 coupled to the control chip 500. The control chip 500 includes a RAM 510, a DSP 520 coupled to the RAM 510, and a DSP code download device 540 directly coupled to the RAM 510. The flash memory 530 is used to store data required by the control chip, for example the DSP code required for the DSP 520. The DSP code is stored in the flash memory 530 with encryption for increasing safety and security.

Unlike the example one, the DSP code download device 540 in the example two is directly connected to the RAM 510 bypassing the DSP 520. With regard to the method for downloading the DSP code and each functional block in the example two, they are similar to that of the example one. Thus, their details will not be described for the sake of brevity.

The present invention utilizes a re-programmable memory, such as a flash memory, to store the DSP code. A circuitry is used for downloading the DSP code each time a peripheral device is activated. A DSP code download device downloads the DSP code stored in the re-programmable memory to a RAM in a control chip of the peripheral device. The DSP code stored in the re-programmable memory is further encrypted for security, and read and write checksum values are used for checking whether the downloaded DSP code is correct or not. According to the present invention, the DSP code that the DSP executes previously can be replaced with a required version by changing the DSP code stored in the flash memory. Thus, whenever a newer version is released or a specific version for replacing the DSP code having errors is available, this required version of DSP code can replace the version of DSP code used previously in an efficient and cost effective approach.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A device of a control chip, for starting a download of a digital signal processor (DSP) code comprises a Servo system control code from a first memory to a second memory, the device comprising:
a first memory reader for downloading the DSP code from the first memory;
a download procedure controller, coupled to the first memory reader; and
a second memory accessor, coupled to the download procedure controller for accessing the second memory.

2. The device of claim 1, wherein the first memory further stores a pointer to indicate an initial address and a code size of the DSP code.

3. The device of claim 1, wherein the DSP code is encrypted and stored in the first memory.

4. The device of claim 1, wherein the first memory is a re-programmable memory.

5. The device of claim 1, wherein the second memory is a re-programmable memory.

6. A control chip, coupled to a first memory with a digital signal processor (DSP) code comprises a Servo system control code, the control chip comprising:
a digital signal processor (DSP);
a second memory, coupled to the DSP; and
a DSP code download device, coupled between the first memory and the second memory for downloading the DSP code.

7. The control chip of claim 6, wherein the DSP code download device further comprises:
a first memory reader for downloading the DSP code from the first memory;
a download procedure controller, coupled to the first memory reader; and
a second memory accessor, coupled to the download procedure controller for accessing the second memory.

8. The control chip of claim 6, wherein the first memory further stores a pointer to indicate an initial address and a code size of the DSP code.

9. The control chip of claim 6, wherein the DSP code is encrypted and stored in the first memory.

10. The control chip of claim 6, wherein the first memory is a re-programmable memory.

11. The control chip of claim 6, wherein the second memory is a re-programmable memory.

12. The control chip of claim 6, further comprising of storing a decrypted DSP code into the second memory through the DSP.

13. A method using a DSP code download device of a control chip for updating a digital signal processor (DSP) code comprises a Servo system control code for controlling a Servo system of a optoelectronic system, the method comprising:
downloading the DSP code stored in the first memory to a second memory according to a pointer stored in the first memory for indicating an initial address and a code size of the DSP code.

14. The method of claim 13, wherein the DSP code stored in the first memory is an encrypted DSP code.

15. The method of claim 13, further comprising of decrypting the DSP code and calculating a read checksum value.

16. The method of claim 15, further comprising the steps of:
reading the decrypted DSP code stored in the second memory, and calculating a write checksum value; and
storing the read and the write checksum values into the second memory.

17. A peripheral device of an optoelectronic system, capable of reprogramming a digital signal processor (DSP) in the optoelectronic system, comprising:
a first memory for storing a first program code comprises a Servo system control code;
a code downloading device, coupled to the first memory, for downloading the first program code and outputting a second program code; and
a second memory, coupled to the code downloading device, for receiving the second program code from the code downloading device;
wherein the DSP is operative with the second program code when the second program code in the second memory passes a verification test performed by the code downloading device.

18. The peripheral device of claim 17, wherein the first program code is encrypted, whereas the second program code is decrypted.

19. The peripheral device of claim 17, wherein the verification test determines whether the second program code is equivalent to the decrypted first program code.

20. The peripheral device of claim 17, wherein the first memory is a re-programmable memory.

21. The peripheral device of claim 17, wherein the second memory is a re-programmable memory.

22. The peripheral device of claim 17, wherein the optoelectronic system is a DVD player or a VCD player.

23. The peripheral device of claim 17, wherein the optoelectronic system is a compact disc-read only memory (CD-ROM) drive or a digital versatile disc (DVD) drive.
